(19) United States
(12) Patent Application Publication
(10) Pub. No.: US 2011/0137872 A1
(43) Pub. Date: Jun. 9, 2011

(54) MODEL-DRIVEN DATA ARCHIVAL SYSTEM HAVING AUTOMATED COMPONENTS

(75) Inventors: Peter A. Coldicott, Austin, TX (US); Mei Y. Selvage, Pocatello, ID (US); Xiao Feng Tao, Shanghai (CN)

(73) Assignee: International Business Machines Corporation, Armonk, NY (US)

(21) Appl. No.: 12/631,014

(22) Filed: Dec. 4, 2009

(51) Int. Cl. G06F 17/00; G06F 12/16

(52) U.S. Cl. 707/665; 707/661; 707/E17.044; 711/E12.001; 711/E12.103; 707/E17.122

(57) ABSTRACT

The present invention relates to a method or system of data archival using model-driven and automated components. It provides a data archiving solution by using model-driven, automated components, such as a transformation component, for a flexible, generic data archive solution. Other components may include a testing component for testing the data archive, a deploying component for deploying the data archive specification model and a feedback component for receiving archive results, observing the archive results and feeding back the archive results for archive model optimization.

### FIELD OF THE INVENTION

The present invention relates to a method or system of data archival using a model-driven and automated components. It provides a data archiving solution by using a model-driven, automated components, such as an analyzing component, a transformation component, a testing component, a deploying component, a feedback component and a model optimization component for a flexible, generic data archiving solution.

### BACKGROUND OF THE INVENTION

One of the primary methods to archive data is for a user to select, move and remove data manually. For instance, database administrators may issue Structured Query Language (SQL) queries or use generic database utilities to search and select against relational databases and save the result as files, and then send via File Transfer Protocol (FTP) to another location. This method may be simple and doesn't create large, upfront cost, but it has disadvantages. Specifically, it creates high risk of archiving the wrong data or not archiving enough data and frequently leads to data integrity issues, so the manual archive method is of potential damage to an enterprise and even result in an enterprise disaster.

Other data archive technologies usually provide a configurable console and programmable tool for data archive. However, these products also have obvious limitations:
These tools may have limited data source and location support. Most of these tools may only support specific relational databases (such as IBM® DB2®, Oracle, etc.), and just archive to tables or flat files. (DB2 is one of the families of relational database management system (RDBMS) software products within IBM's broader Information Management Software line. DB2®, is a registered trademark of International Business Machines Corporation. The Oracle Database (commonly referred to as Oracle RDBMS or simply Oracle) consists of a RDBMS produced and marketed by Oracle Corporation. Oracle® is a registered trademark of Oracle Corporation.).
These tools may have limited data type support. Most of them only support common data types in a relational database.
Some archive tools just simply copy the documents (files), commonly called backup, and never consider business logic. However, data archive is very sensitive to business logic. Such solutions are not sufficient.
Also, these tools may not be flexible enough to change archive rules.
Most importantly, none of them use model-driven development (MDD) to model data archive specifications (i.e., requirements), then transform specifications into executable code.

Therefore, there is a need to solve the problems associated as described above.

### SUMMARY OF THE INVENTION

The present invention provides a system and methods for data archiving. The present invention provides a flexible, generic data archiving solution using a model-driven approach. It provides model-driven development (MDD) to model data archive specifications, then transform specifications into executable code.

The data archive of the present invention is the operation of moving data from original data repository into archive data repository. A model-driven, automated transformation component of the present invention is architected based on a “plug-in” mechanism. After the context of the data archive of an enterprise application has been analyzed and a data archive specification model has been defined, two transformation steps are performed:
A first step may be to transform a data archive specification model into a set of native-based (more machine-friendly), e.g., an XML-based, archive specification. These specifications record all the necessary information that the data archive needs.
A second step may be to transform the native-based, e.g., XML-based, archive specification into native archive codes/rules/specifications for corresponding archive engines.

Further, the present invention provides a method for flexible data archival using a model-driven approach in a system having an application having a data archive having a context and further having an application having content, the method may comprise analyzing the data archive context of the application, defining a data archive specification model, transforming the data archive specification model into an archive specification, recording information that data archive needs, and transforming the archive specification into native archive specifications for corresponding archive engines.

Further, the present invention provides a computer system for flexible data archival using a model-driven approach that may have a CPU, a computer readable memory and a computer readable storage media, program instructions to analyze a data archive specification model specifying a data archive, and program instructions to transform the data archive specification model into a native data archive specification and for transforming the native data archive specification into generated code and to generate code.

The present invention further provides a computer program product for flexible data archival, the computer program product may have a computer readable storage media, program instructions to analyze the data archive context of the application, program instructions to define a data archive specification model, program instructions to transform the data archive specification model into an archive specification, program instructions to recording information that data archive needs and program instructions to transforming the archive specification into one or more native archive specifications for corresponding archive engines, and wherein the program instructions are stored on the computer readable storage media.

In addition, the present invention provides a method for deploying a computing infrastructure comprising integrating computer-readable code into a computing system, wherein the code in combination with the computing system is capable of performing a process for archiving data, the process comprising analyzing the data archive context of the application, defining a data archive specification model, transforming the data archive specification model into an archive specification, recording information that data archive needs and transforming the archive specification into native archive specifications for corresponding archive engines.

### BRIEF DESCRIPTION OF THE DRAWINGS

These and other features of this invention will be more readily understood from the following detailed description of the various aspects of the invention taken in conjunction with the accompanying drawings in which:

FIG. 1 shows a data processing system suitable for implementing an embodiment of the present invention.

FIG. 2 shows a network for implementing an embodiment of the present invention.

FIG. 3 illustrates an embodiment of a method and system of the present invention.

FIG. 4 illustrates a method for implementing the system and method of the present invention.

FIG. 5 illustrates another embodiment of the method of the present invention.

FIG. 6 illustrates an example data archive XML specification that may be created by the system and method of the present invention.

The drawings are not necessarily to scale. The drawings are merely schematic representations, not intended to portray specific parameters of the invention. The drawings are intended to depict only typical embodiments of the invention, and therefore should not be considered as limiting the scope of the invention.

### DETAILED DESCRIPTION OF THE INVENTION

The present invention comprises a system and method for archiving data. The system and method of the present invention consider data archiving on an enterprise business objects level, not on database records, tables and files level. Data archiving is business-oriented and difference enterprise applications have different data archive rules. It is very important to have a flexible, generic end-to-end data archive solution that is business-oriented, independent from individual applications, databases and systems.

Some of the advantages of using the system and method of the present invention are the following. It allows for automating an end-to-end data archive process. End users do not need to write code as the data archive is developed by a model-driven process. It enables, by going from specification to transformation, a more accurate capture and transition from requirements to codes, reduces the maintenance, and speeds up development time. It offers a standard based approach by using UML, XML, SQL, Web Service, JDBC, etc. (Unified Modeling Language (UML) is a standardized general-purpose modeling language in the field of software engineering. XML (Extensible Markup Language) is a set of rules for encoding documents electronically. SQL (Structured Query Language) is a database computer language designed for managing data in relational database management systems (RDBMS). A Web service (also Web Service) is defined by the W3C as “a software system designed to support interoperable machine-to-machine interaction over a network”. JDBC (Java database connectivity) is an API for the Java programming language that defines how a client may access a database. Java and all Java-based trademarks and logos are trademarks of Sun Microsystems, Inc. in the United States, other countries, or both.)

The solution of the present invention is implementable for a variety of data sources and commercial relational databases. There is no need to rely on proprietary archive implementations for specific data sources. It allows for dynamically obtaining metadata information and generating SQL for data archiving. It allows for handling the complicated metadata information with accuracy. It ensures the compatibility of data type. It improves the consistency and quality of solutions and, in addition to generating code, it is easy to generate documentation, test artifacts, build and deployment scripts, etc.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system”. Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires; a portable computer diskette; a hard disk; a random access memory (RAM); a read-only memory (ROM); an erasable programmable read-only memory (EPROM or Flash memory); an optical fiber; a portable compact disc read-only memory (CD-ROM); an optical storage device, a magnetic storage device; or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wire line, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. Smalltalk is an object-oriented, dynamically typed, reflective programming language. Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. Smalltalk is an object-oriented, dynamically typed, reflective programming language. C++ is a statically typed, free-form, multi-paradigm, compiled, general-purpose programming language.

In the latter scenario, the remote computer may be connected to the user's computer through any type of network, including a local area network (LAN) or a wide area network (WAN), or the connection may be made to an external computer (for example, through the Internet using an Internet Service Provider). In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions.

These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

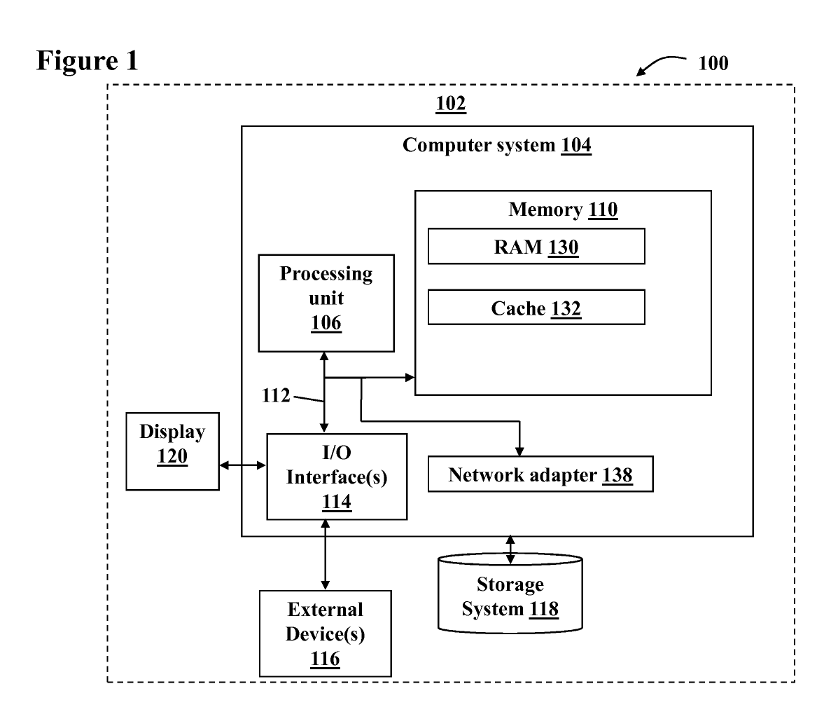

FIG. 1 shows a system 100 that may have a data processing system 102 suitable for implementing an embodiment of the present invention. Data processing system 102 may have a computer system 104 connected to a display 120, external device(s) 116 or other peripheral devices for providing a user an interface to computer system 104 being connected via I/O interface(s) 114. Computer system 104 may have an internal bus 112 for providing internal communication between such modules as processing unit 106, I/O interface(s) 114, network adapter 138 and memory 110. Memory 110 may have random access memory (RAM) 130, cache 132 and storage system 118 or other forms of memory. RAM may take the form of integrated circuits that allow stored data to be accessed in any order (i.e., at random). Storage system 118 may take the form of tapes, magnetic discs and optical discs and are generally used for long term storage of data. Cache 132 is a memory for storing a collection of data—duplicating original values stored elsewhere or computed earlier, where the original data is expensive to fetch (owing to longer access time) or to compute, compared to the cost of reading the cache. In other words, a cache is a temporary storage area where frequently accessed data can be stored for rapid access. Once the data is stored in the cache, it can be used in the future by accessing the cached copy rather than re-fetching or re-computing the original data. A cache has proven to be extremely effective in many areas of computing because access patterns in typical computer applications have locality of reference.

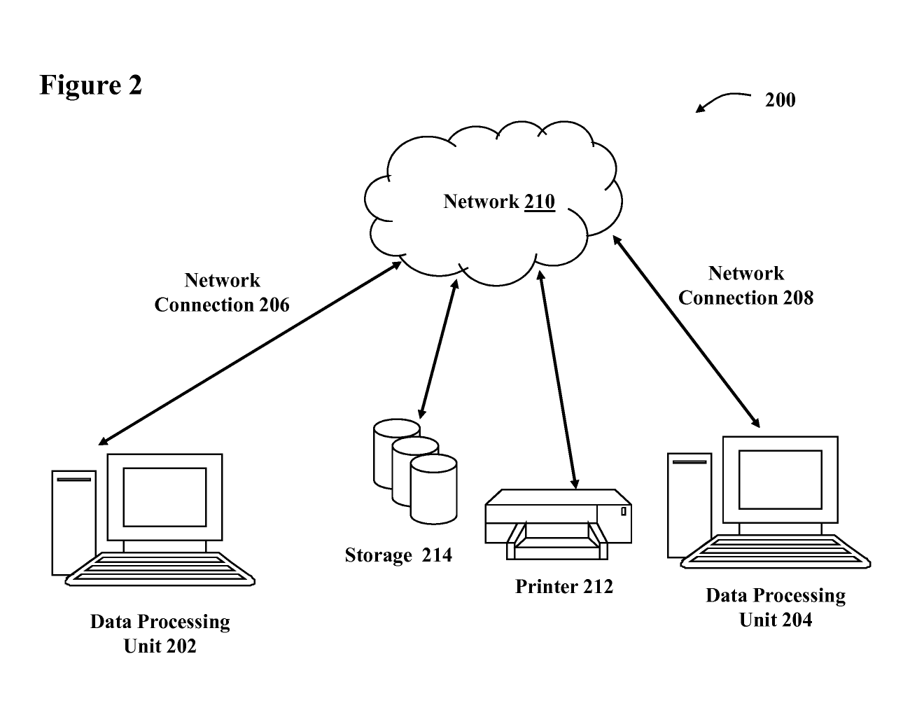

FIG. 2 shows a network system 200 for implementing an embodiment of the present invention. Network system 200 may have a network 210 or group of interconnected computers, such as data processing units 202, 204, via network connections 206, 208 and may be of the type, e.g., a local area network (LAN) or internetwork. Printer 212 and storage 214 may be connected to network 210 via network connections 216, 218. Basic network components may include network interface cards, repeaters, hubs, bridges, switches and routers. Data processing units 202, 204 may be computers such as web servers or personal computers, or other user agents. A web server generally has hardware and software that are responsible for accepting HTTP requests from clients (user agents such as web browsers), and serving them HTTP responses along with optional data contents, which usually are web pages such as HTML documents and linked objects (images, etc.). In this document, the term “web browser” is used but any application for retrieving, presenting, and traversing information resources on the Internet must be considered.

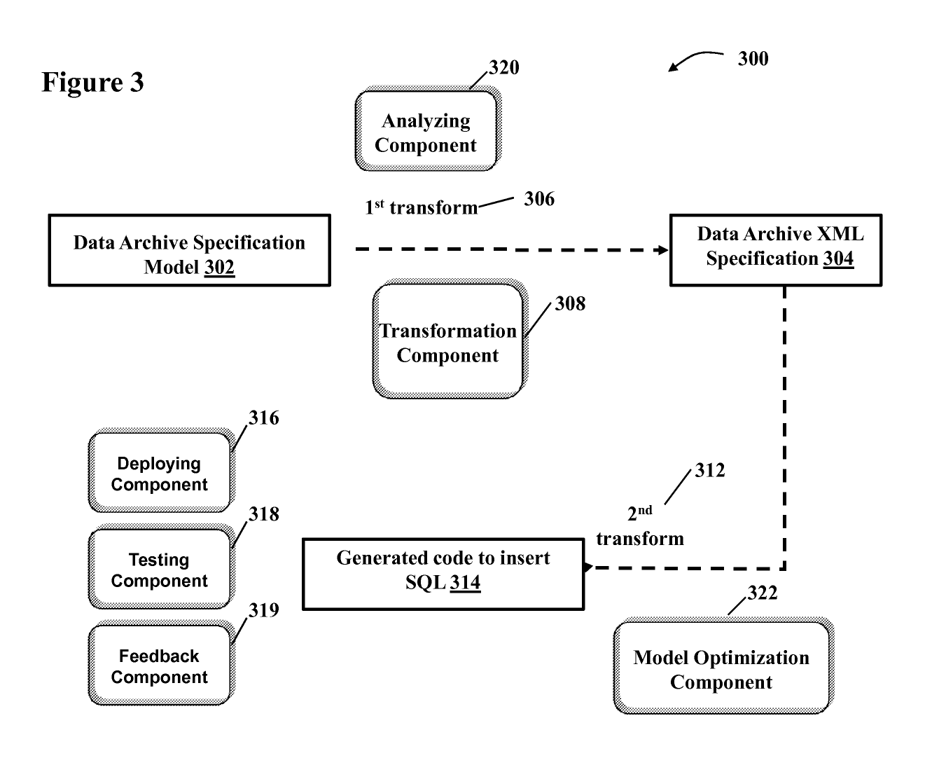

In a first step, the input is created by a user as a data archive specification model 302 as shown in FIG. 3 at 300. It could be created in an Eclipse platform, but it can also be created in a Web or stand-alone application with or without a user interface (UI). It is analyzed by an analyzing component 320 that analyzes the data archive context of the application and then transformed for a first time at 306 by a transformation component 308 to create data archive native specifications 304, such as XML specifications. Analyzing component 320 may have program instructions to analyze the data archive context of the application. At 312, data archive XML specifications 304 is transformed a second time at 312 by transformation component 308 to create generated code to perform archive functions. The example here is to insert SQL 314 to a relational database. Transformation component 308 may have program instructions to define a data archive specification model and program instructions to transform the data archive specification model into an archive specification. Specific outcomes of transformation component 308 may defer based on data sources and data archive specifications. Deploying component 316 deploys the data archive application. Deploying component 316 may have program instructions to recording information that data archive needs. Transformation component 308 may have program instructions to transforming the archive specification into one or more native archive specifications for corresponding archive engines wherein the program instructions are stored on computer readable storage media and may have program instructions to transform the data archive specification into a native archive specification based upon the native archive specification codes and rules. Transformation component 308 may also have program instructions to transform the data archive specification model to an XML-based data archive specification and program instructions to transform the native archive specification into generated code. Deploying component 316 may further have program instructions to deploy the data archive specification model. Testing component 318 tests the data archive application and a feedback component 319, receives archive results, observes the archive results and feeds back the archive results for archive model optimization. Testing component 308 may have program instructions to test the archive application. Feedback component 319 may have program instructions to receive archive results, to observe the archive results and to feed back the archive results for archive model optimization. A model optimization component 322 receives archive results from the testing component, observes the archive results and feeds back the archive results to the transformation component 308 for archive model optimization.

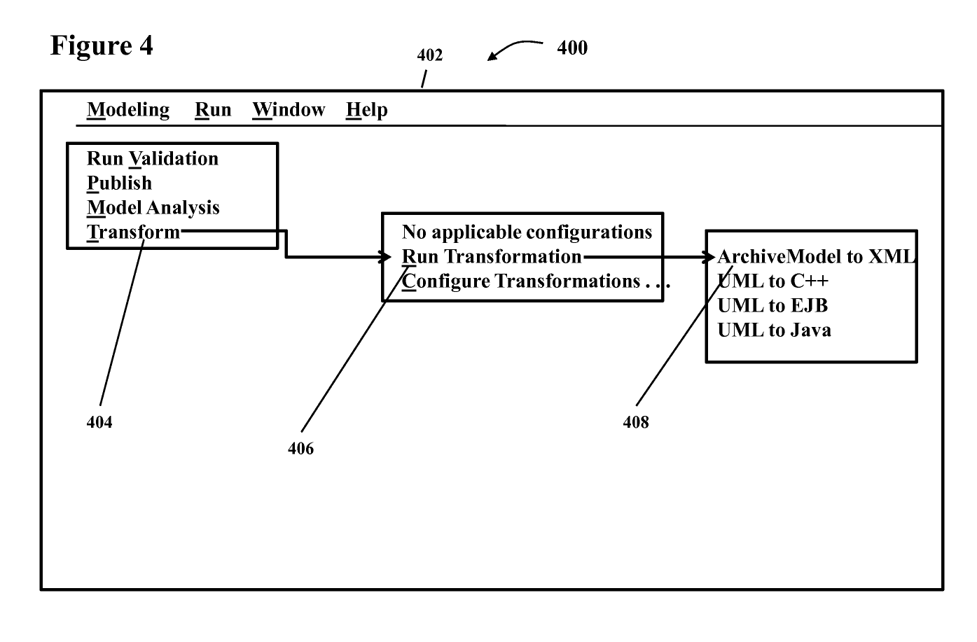

FIG. 4, at 400, shows a sample UI on how to invoke a first transformation for a data archive specification model in Eclipse through the menu bar. Eclipse is a multi-language software development environment comprising an IDE and a plug-in system to extend it. An integrated development environment (IDE) also known as integrated design environment or integrated debugging environment is a software application that provides comprehensive facilities to computer programmers for software development. Alternatively, the user may also merely right click on the Eclipse workspace 402, invoke the transformation menu: Transform 404=>Run Transformation 406=>ArchiveModel to XML 408.

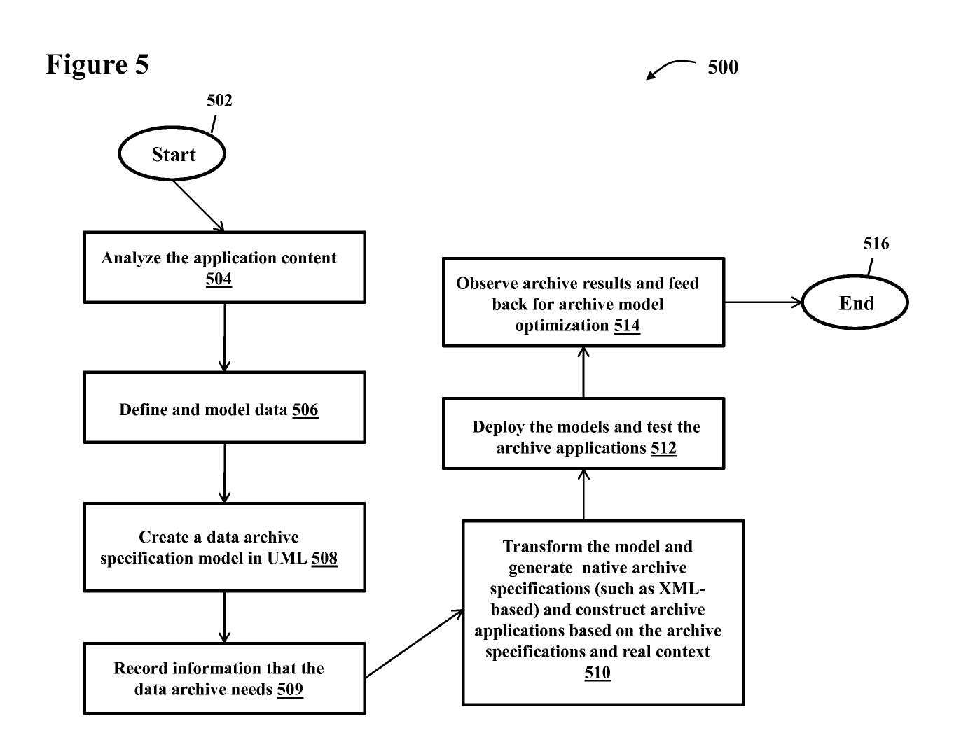

There are four major steps to use the flexible, generic data archive solution of the present invention as shown as 500 in FIG. 5 which starts at 502. The first is to analyze the application content at 504. By analyzing the application content, one may identify data archive requirements and capture information related to data types, relationships and archive rules. The second is to define and model archive data at 506. By defining and archiving data, one may define data archive models based on a meta-model provided in the present invention and model the data archive based on graphical modeling tools, e.g. Eclipse-based tools. “Meta-modeling” is the construction of a collection of “concepts” (things, terms, etc.) within a certain domain. A model is an abstraction of phenomena in the real world; a meta-model is yet another abstraction, highlighting properties of the model itself.

After the completion of the second step 506, a data archive specification model in UML may be created at 508. Unified Modeling Language (UML) is a standardized general-purpose modeling language in the field of software engineering. While UML is used in the document, any other suitable modeling language may be used. Using the present invention, one may specify and model different perspectives of a set of archive data in an enterprise application, such as what is to be archived, for example, data, data types, relationships, data filtering conditions and when and how to archive, that is, archive rules.

The third may be to perform a model transformation and generating a native archive specification (such as XML-based) and construct an archive application based on the archive specification and real context and content at 510. At 511, information that data archive needs may be recorded.

The fourth is to deploy the models and test the archive application at 512. Optionally, the method and system of the present invention may optimize the archive model by observing archive result and feeding back for archive model optimization at 514. The method may end at 516.

The system and method of the present invention has many advantages. It provides a business advantage by improving performance of operational applications, saving administration cost, hardware and storage cost. It provides a fast response to archive requirements and mitigates risks for regulatory compliance. It decreases time-to-market by shortening the project lifecycle. It may increase competency in data management market by leveraging corresponding data archive products and may increase revenue from the data market by leveraging corresponding data archive products. It may provide a technical advantage as it is flexible, because solution is based on model driven development method, and provides a good user experience, because graphical modeling tools are available.

The model-driven method and system of the present invention allows a user to give more focus on archive requirements and rules, instead of construction of specified archive application. It may be an open standard-based (such as an XML-based archive specification), that can support more existing archive tools. An XML-based archive specification may be considered as canonical data model for archiving purposes.

The model-driven method and system of the present invention provides a generic data archive solution, not only limited to specified data and specified data storage/management systems wherein data archive solutions can work independently, or with existing enterprise archive solutions, such as IBM® DB2® Archive Expert or SAP AG's SAP Archive Tool. IBM and DB2 are registered trademarks of International Business Machines Corporation. SAP is a trademark of SAP AG.

One method of the present invention performs the following steps:
1. analyzing a data archive context of an enterprise application;
2. defining a data archive specification model;
3. performing transformations from the data archive model-based model to a native specification, such as XML-based; and
4. transforming the native specification into generated code.

Once the transformation is finished, the native archive code/rules/specifications may be deployed into corresponding archive engines. Then, a new data archive application may start to run. The core of the data archive solution in the present invention lies in a flexible, extensible meta-model component. All necessary metadata information for a data archive definition is contained in the data archive meta-model.

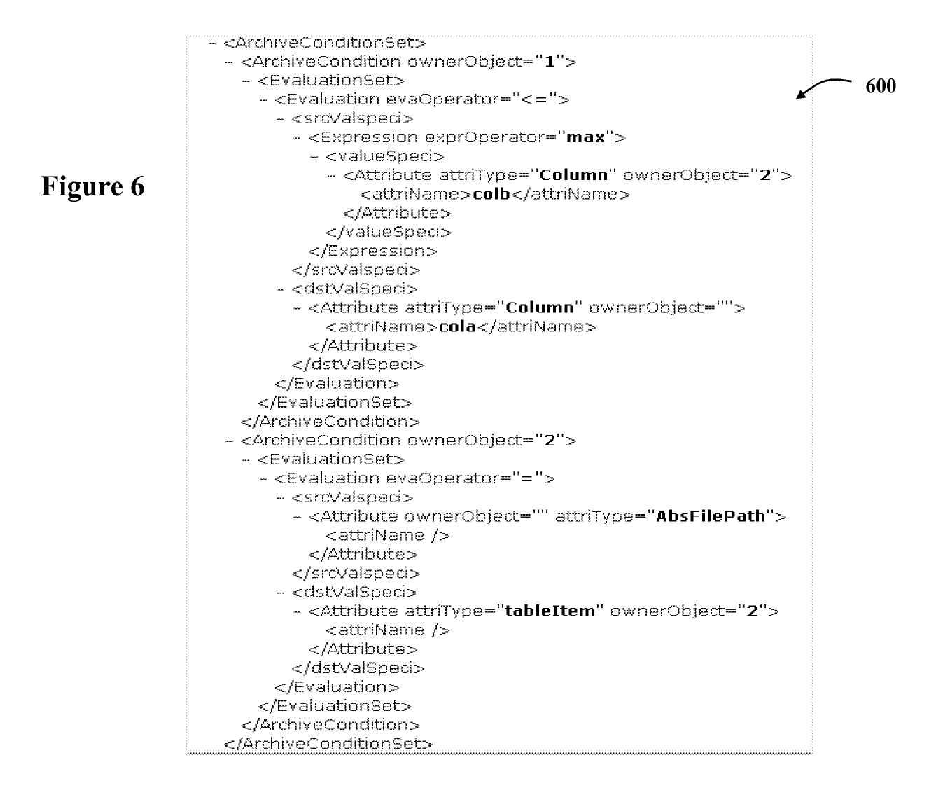

FIG. 6 illustrates an example data archive XML specification 600 (Data Archive XML Specification 304 in FIG. 3) that may result after the first transformation at 306 of data archive specification model 302 of FIG. 3.

A process for deployment of a system of the present invention can comprise one or more process steps of installing program code on a computing device, such as computer system from a computer-readable medium, adding one or more computing devices to the computer infrastructure, and incorporating and/or modifying one or more existing systems of the computer infrastructure to enable the computerized infrastructure to perform the process steps of the invention.

As used herein, it is understood that the terms “program code” and “computer program code” are synonymous and mean any expression, in any language, code or notation, of a set of instructions intended to cause a computing device having an information processing capability to perform a particular function either directly or after either or both of the following: (a) conversion to another language, code or notation; and/or (b) reproduction in a different material form. To this extent, program code can be embodied as one or more of: an application/software program, component software/a library of functions, an operating system, a basic I/O system/driver for a particular computing and/or I/O device, and the like.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of the invention as defined by the accompanying claims.

What is claimed is:

1. A method for flexible data archival using a model-driven approach in a system having an application having a data archive having a context and further having an application having content, the method comprising:
analyzing the data archive context of the application;
defining a data archive specification model;
transforming the data archive specification model into a native archive specification;
recording information that data archive needs; and
transforming the native archive specification into generated code for corresponding archive engines.

2. The method as defined in claim 1 further comprising transforming the archive specification model into a native archive specification based upon native archive specification codes and rules.

3. The method as defined in claim 2 further comprising transforming the archive specification model to an XML-based data archive specification.

4. The method as defined in claim 3 further comprising transforming the native archive specification into generated code in SQL.

5. The method as defined in claim 4 further comprising deploying the data archive specification model.

6. The method as defined in claim 5 further comprising testing the native archive application and providing archive results.

7. The method as defined in claim 6 wherein the further comprising receiving archive results, observing the archive results and feeding back the archive results for archive model optimization.

8. A computer system for flexible data archival using a model-driven approach comprising:
a CPU, a computer readable memory and a computer readable storage media;
program instructions to analyze a data archive specification model specifying a data archive; and
program instructions to transform the data archive specification model into a native data archive specification and for transforming the native data archive specification into generated code and to generate code.

9. The computer system as defined in claim 8 further comprising program instructions to test the data archive and generating archive results.

10. The computer system as defined in claim 9 further comprising program instructions to deploy the data archive specification model.

11. The computer system as defined in claim 10 further comprising program instructions to receive archive results from the testing component, to observe the archive results and to feed back the archive results for archive model optimization.

12. A computer program product for flexible data archival, the computer program product comprising:
a computer readable storage media;
program instructions to analyze the data archive context of the application;
program instructions to define a data archive specification model;
program instructions to transform the data archive specification model into an archive specification;
program instructions to record information that data archive needs; and
program instructions to transform the archive specification into one or more native archive specifications for corresponding archive engines, and wherein the program instructions are stored on the computer readable storage media.

13. The computer program product as defined in claim 12 further comprising program instructions to transform the data archive specification into a native archive specification based upon the native archive specification codes and rules.

14. The computer program product as defined in claim 13 further comprising program instructions to transform the data archive specification model to an XML-based data archive specification.

15. The computer program product as defined in claim 14 further comprising program instructions to transform the native archive specification into generated code.

16. The computer program product as defined in claim 15 further comprising program instructions to deploy the data archive specification model.

17. The computer program product as defined in claim 16 further comprising program instructions to test the archive application.

18. The computer program product as defined in claim 17 further comprising program instructions to receive archive results, to observe the archive results and to feed back the archive results for archive model optimization.

19. A method for deploying a computing infrastructure comprising integrating computer-readable code into a computing system, wherein the code in combination with the computing system is capable of performing a process for archiving data, the process comprising:
analyzing the data archive context of the application;
defining a data archive specification model;
transforming the data archive specification model into an archive specification;
recording information that data archive needs; and
transforming the archive specification into native archive specifications for corresponding archive engines.

20. The method as defined in claim 19 wherein the process further comprises transforming the data archive specification into a native archive specification based upon native archive specification codes and rules.
